(19) United States
(12) Patent Application Publication
(10) Pub. No.: US 2025/0383223 A1
(43) Pub. Date: Dec. 18, 2025

(54) LIQUID LEVEL DETECTOR

(71) Applicant: Iveda Solutions, Inc., Mesa, AZ (US)

(72) Inventors: DAVID HIEU LY, Chandler, AZ (US); SZU HAN CHEN, Taipei (TW); YUN SHENG LIU, Hsinchu City (TW)

(21) Appl. No.: 18/740,988

(22) Filed: Jun. 12, 2024

(51) Int. Cl. G01F 23/00; G01D 11/30

(52) U.S. Cl. CPC G01F 23/0046; G01D 11/30; G01F 23/0007

(57) ABSTRACT

Sensors detect liquid level and holders support sensors. Different embodiments have one, two, three, or more sensors and holders positioned to detect different liquid levels. A holder may have two parts that connect around a pipe and hold a sensor against the pipe to detect liquid level in the pipe. A spacer within the holder may be manufactured in different dimensions to accommodate different pipe sizes. Different sensors and holders may be interchangeable and the sensor, spacer, or both, may contact the pipe. Sensors may be electronically read, ultrasonic, capacitive, or radar, the liquid may be oil, and the pipe may connect to a tank holding the liquid. Pipe may be substantially vertical, non-metallic, or plastic and the holder may be plastic.

### FIELD THE INVENTION

Various embodiments of this invention relate to apparatuses, processes, and systems for detecting a level of a liquid, for example, using at least one sensor. Particular embodiments, for instance, include at least one holder for a sensor.

### BACKGROUND OF THE INVENTION

Various sensors have been used to detect the level of various liquids. Ultrasonic sensors have been used, for example, including to detect the presence or level of oil. Further, sensors have been combined with a sight oil level gage. Still further, A signal from a sensor has been produced containing information about the level of a liquid, including oil. Even further, a sight glass has provided a visual verification that a sensor is working correctly in relation to the fluid visible in the sight glass. Further still, tubes, including measuring tubes and immersion pipes, have been used with sensors, including ultrasonic sensors, to measure a liquid level, including an oil level. Capacitive touch sensors have also been used. Room for improvement exists, however, in liquid level detection. For example, potential for benefit exists in the way liquid levels are obtained, handled, and communicated, and in the systems and devices used to do so. Potential for benefit exists, for instance, for apparatuses, processes, and systems that are more versatile, less expensive, more reliable, communicate more effectively, or a combination thereof, as examples. Further, room for improvement exists in holders for sensors used to detect liquid level, and in the way such holders are used to form a larger system or apparatus. Potential for benefit exists in these and other areas that may be apparent to a person of skill in the art who has studied this document.

### SUMMARY OF PARTICULAR EMBODIMENTS OF THE INVENTION

Various embodiments detect a level of a liquid. Further, various embodiments form, or are part of, an apparatus that detects a liquid level. Different embodiments include different combinations of specific components or elements. For instance, various embodiments include one or more liquid level sensors, one or more sensor holders, or a combination thereof. Further still, in particular embodiments, the sensors, holders, or both, may be of a specific type, include specific parts or features, or a combination thereof. Even further, various embodiments include improvements, for example, in liquid level detection. For instance, certain embodiments improve the way liquid levels are obtained, handled, and communicated, in the systems or devices used to do so, or both. In some embodiments, apparatuses, processes, systems, or a combination thereof, are more versatile, less expensive, more reliable, communicate more effectively, or a combination thereof, for instance. Improvements exist in these and other areas that may be apparent to a person of skill in the art who has studied this document.

Specific embodiments are or include, for example, an apparatus for detecting a level of a liquid. In a number of embodiments, for instance, the apparatus includes a first sensor, for example, that detects a first level of the liquid. In addition, various embodiments include a first holder, for instance, that supports the first sensor. Further, in various embodiments, the first holder includes a first part and a second part. Further still, in a number of embodiments, the first part connects to the second part (e.g., around a pipe), the first sensor contacts the first part, the first sensor contacts the pipe, or a combination thereof, as examples. Even further, in various embodiments, the first sensor detects the first level of the liquid, for instance, in the pipe.

Moreover, in some embodiments, the apparatus further includes a second sensor, for example, that detects a second level of the liquid, a second holder, for instance, that supports the second sensor, or both. Further, in particular embodiments, the second level of the liquid is different than the first level of the liquid. Still further, in various embodiments, the second holder is interchangeable with the first holder, the second sensor contacts the pipe, the second sensor detects the second level of the liquid (e.g., in the pipe), or a combination thereof, as examples. Even further, in a number of embodiments, the second sensor is interchangeable with the first sensor.

Furthermore, in certain embodiments, the apparatus further includes a third sensor, for example, that detects a third level of the liquid, a third holder, for instance, that supports the third sensor, or both. Further still, in various embodiments, the third level of the liquid is different than the first level of the liquid, the third level of the liquid is different than the second level of the liquid, or both. Even further, in a number of embodiments, the third holder is interchangeable with the first holder, the third sensor contacts the pipe, the third sensor detects the third level of the liquid (e.g., in the pipe), or a combination thereof, for example.

Further, in particular embodiments, the first holder includes a spacer. In some embodiments, for example, the spacer is located between the pipe and the second part, the spacer contacts the pipe, the second part contacts the spacer, or a combination thereof, for instance. Still further, in a number of embodiments, the spacer is manufactured in different dimensions, for example, to accommodate different sizes of the pipe (e.g., while utilizing common sizes of the first part, the second part, or both). Even further, in various embodiments, the first holder surrounds the pipe, the first part connects to the second part on substantially opposite sides of the pipe, or both. Further still, in some embodiments, the pipe is substantially vertical, the pipe is non-metallic, the first part, the second part, or both, are plastic, or a combination thereof. In some embodiments, the first sensor is electronically read. Further, in particular embodiments, the apparatus includes a gateway box, for example, electrically connected to the first sensor. Still further, in a number of embodiments, the first sensor is an ultrasonic, capacitive, or radar sensor, as examples. Even further, in various embodiments, the liquid is oil. Even further still, in certain embodiments, the pipe is connected to a tank, the first sensor detects the first level of the liquid in the tank, or both.

Another example of a specific embodiment is an apparatus for detecting a level of a liquid that includes a first sensor (e.g., that detects a first level of the liquid), a first holder (e.g., that supports the first sensor), a second sensor (e.g., that detects a second level of the liquid), a second holder (e.g., that supports the second sensor), or a combination thereof. Further, in a number of embodiments, the first holder contacts a pipe, the first sensor detects the first level of the liquid (e.g., in the pipe), or both. Further still, in various embodiments, the second level of the liquid is different than the first level of the liquid. Even further, in some embodiments, the second sensor contacts the pipe, the second sensor detects the second level of the liquid (e.g., in the pipe), or both.

In addition, in particular embodiments, the apparatus further includes a third sensor (e.g., that detects a third level of the liquid), a third holder (e.g., that supports the third sensor), or both. Still further, in various embodiments, the third level of the liquid is different than the first level of the liquid, the third level of the liquid is different than the second level of the liquid, or both. Even further, in a number of embodiments, the third holder is interchangeable with the first holder, the third sensor contacts the pipe, the third sensor detects the third level of the liquid (e.g., in the pipe), or a combination thereof. Further still, in certain embodiments, the first holder further includes a spacer, the spacer contacts the pipe, the spacer is manufactured in different dimensions (e.g., to accommodate different sizes of the pipe), or a combination thereof. Even further still, in various embodiments, the second sensor is interchangeable with the first sensor, the first holder surrounds the pipe, the pipe is substantially vertical, the pipe is non-metallic, the holder is plastic, the first sensor is electronically read, The first sensor is an ultrasonic, capacitive, or radar sensor, the liquid is oil, the pipe is connected to a tank, the first sensor detects the first level of the oil (e.g., in the tank), or a combination thereof. Moreover, various other embodiments of the invention are also described herein, and other benefits of certain embodiments are described herein or may be apparent to a person of skill in this area of technology.

### BRIEF DESCRIPTION OF THE DRAWINGS

FIG. 1 is an isometric view illustrating an example of an apparatus that has three sensors for detecting a level of a liquid;

FIG. 2 is a close-up view of part of the apparatus shown in FIG. 1 better illustrating the three sensors, each with its own holder;

FIG. 3 is a close-up view of part of the apparatus shown in FIG. 1 even better illustrating one of the three sensors and its holder;

FIG. 4 is an isometric assembly view of one sensor and holder of the apparatus shown in FIGS. 1-3;

FIG. 5 is a side assembly view of the sensor and holder shown in FIG. 4;

FIG. 6 is a top assembly view of the sensor and holder shown in FIG. 4; and

FIG. 7 is an exploded isometric view of the sensor and holder of FIGS. 4-6, which is one sensor and holder of the apparatus shown in FIG. 1.

The drawings provided herewith illustrate, among other things, examples of certain aspects of particular embodiments. Other embodiments may differ. Various embodiments may include aspects shown in the drawings, described in the specification (including the claims), known in the art, or a combination thereof, as examples.

### DETAILED DESCRIPTION OF EXAMPLES OF EMBODIMENTS

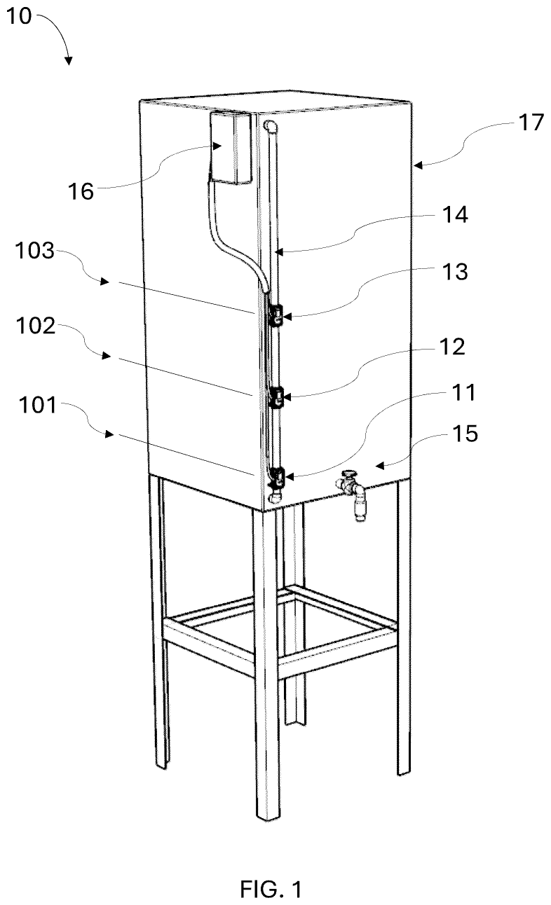

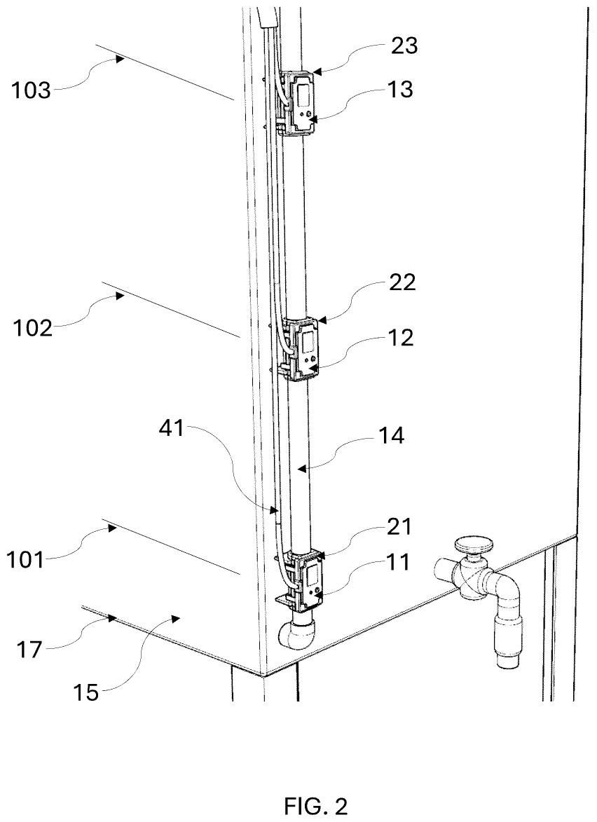

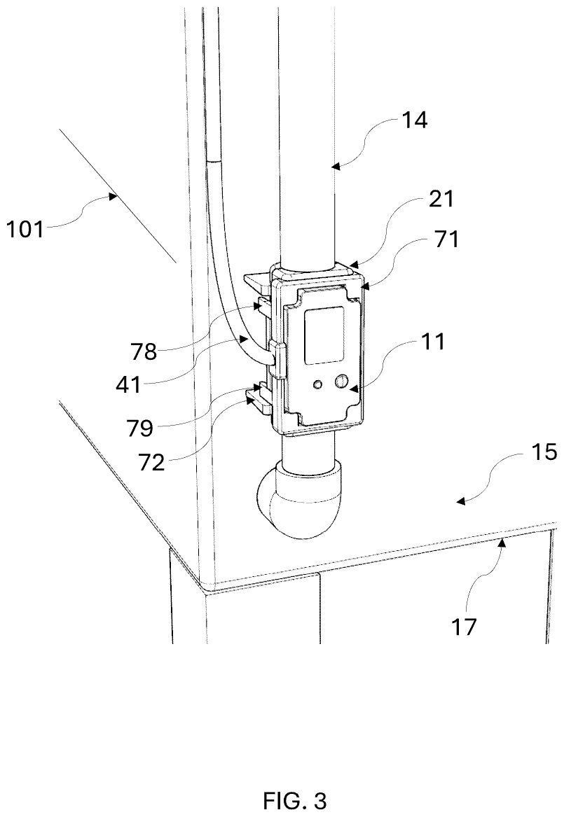

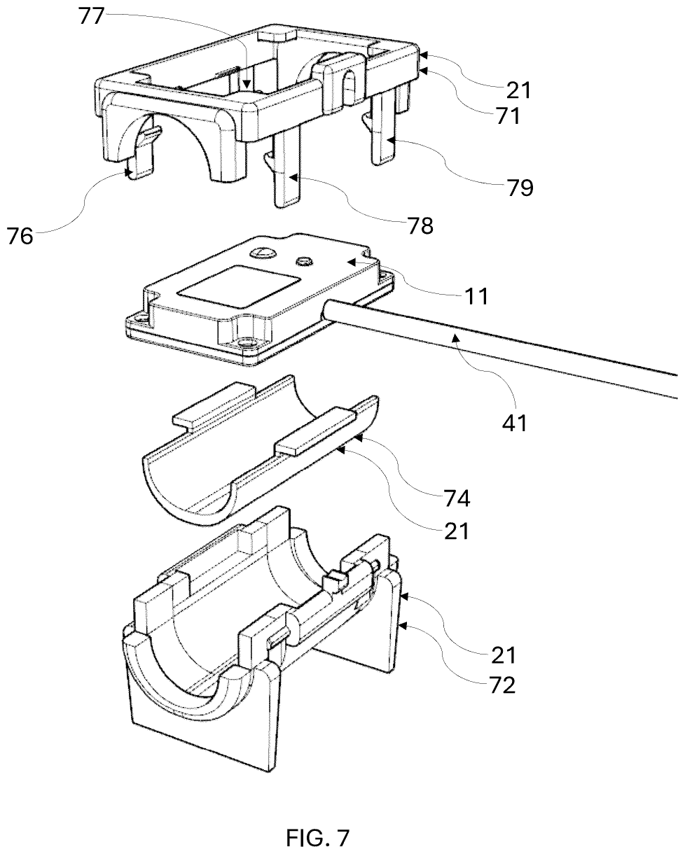

This patent application describes, among other things, various apparatuses, processes, and systems, for example, for detecting a level of a liquid. The figures illustrate an example. Specifically, FIG. 1 illustrates apparatus 10 for detecting a level of a liquid. Apparatus 10 includes first sensor 11, in the embodiment shown, that detects first level 101 of liquid 15 in tank 17. First sensor 11, for example, may detect, indicate, or both, whether liquid 15 in tank 17 is above or below first level 101. In embodiments having multiple sensors, each sensor may perform a similar function. In the embodiment illustrated, apparatus 10 also includes first holder 21 shown in FIGS. 2-7. In this embodiment, first holder 21 supports (e.g., holds or provides a mounting for) first sensor 11. For clarity, first sensor 11 is shown separated from (multiple part) first holder 21 in FIG. 7. Further, as shown separated in FIG. 7, but also shown assembled in FIGS. 3-6, first holder 21, in the embodiment illustrated, includes first part 71 and second part 72. Further, as shown in FIGS. 3-6, first part 71 connects (i.e., attaches) to second part 72, in the illustrated embodiment, around pipe 14 shown in FIGS. 2 & 3. In this context, “around” means greater than 180 degrees around, as measured from the centerline of pipe 14. In the embodiment shown, however, holder 21 extends 360 degrees around pipe 14 when first part 71 connects to second part 72 around pipe 14, as shown in FIGS. 2 & 3 for example. The same is true for holders 22 & 23 (e.g., in FIG. 2). Further, in the embodiment shown, first sensor 11 contacts (i.e., touches) first part 71, and first sensor 11 contacts pipe 14 (e.g., when assembled and in operation, for example, as shown in FIG. 3). Even further, referring to FIGS. 1-3, in this particular embodiment, first sensor 11 detects first level 101 of liquid 15 in pipe 14. In the embodiment shown, pipe 14 connects to (i.e., is in fluid communication with) tank 17 at the bottom and top of pipe 14 as shown. Consequently, the level of liquid 15 is, for all practical purposes, the same in tank 17 and pipe 14 at any given time. Further, liquid 15 levels 101, 102, & 103 occur essentially equally in tank 17 and pipe 14 at essentially the same time.

Moreover, in the embodiment shown, apparatus 10 further includes second sensor 12 (e.g., shown in FIGS. 1 & 2), that detects second level 102 (also shown in FIGS. 1 & 2) of liquid 15. Second sensor 12 may be the same as, or interchangeable with, first sensor 11 (e.g., shown in FIGS. 1-7). In the embodiment shown, second sensor 12 is supported by second holder 22 shown in FIG. 2. Second holder 22 may be the same as, or interchangeable with, first holder 21 (e.g., shown in FIGS. 2-7). For example, first holder 21 and second holder 22 may be manufactured to be identical, for instance, within appropriate manufacturing tolerances. In some embodiments, the same may be true for holder 23 described below. Further, as shown, second level 102 of liquid 15 is different (e.g., higher, as shown) than first level 101 of liquid 15. Even further, in this embodiment, second sensor 12 contacts pipe 14, and second sensor 12 detects second level 102 of liquid 15 in pipe 14. Furthermore, in the embodiment shown (e.g., in FIGS. 1 & 2), apparatus 10 further includes third sensor 13 that detects third level 103 of liquid 15. Moreover, apparatus 10, in the embodiment illustrated (e.g., in FIG. 2), further includes third holder 23 that supports third sensor 13. Further still, third level 103 of liquid 15 is different (e.g., higher, in the embodiment illustrated) than either first level 101 or second level 102 of liquid 15. Even further, in the embodiment illustrated, third holder 23 is interchangeable with first holder 21, third sensor 13 contacts pipe 14, and third sensor 13 detects third level 103 of liquid 15 in pipe 14. Although the embodiment shown in FIGS. 1 & 2 includes three sensors 11, 12, & 13, and three holders 21, 22, & 23, other embodiments may have a different number of sensors and holders, for example, 1, 2, 4, 5, 6, 7, 8, 9, 10, 12, 15, or more. In various embodiments, the number of holders equals the number of sensors. Further, in some embodiments, all sensors are interchangeable, all holders are interchangeable, or both.

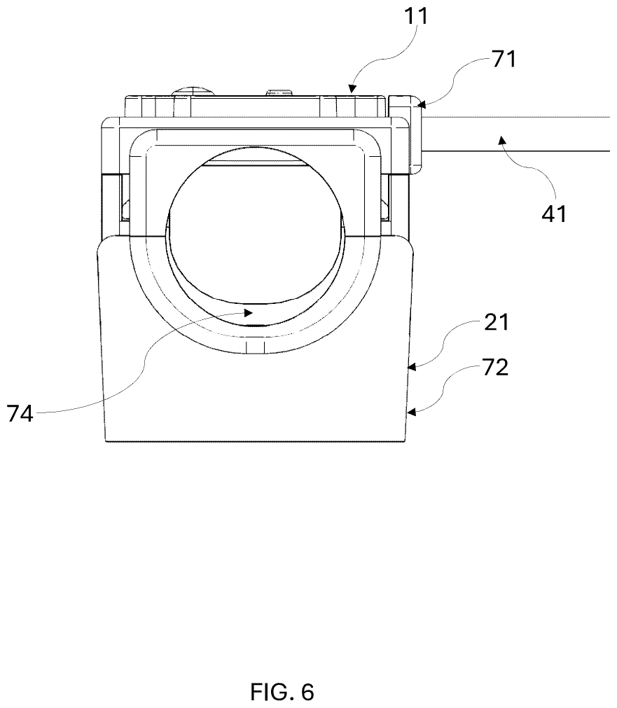

Referring to FIG. 7, first holder 21 includes spacer 74 in the embodiment shown. Spacer 74 is also visible in FIG. 6. In the embodiment illustrated, when apparatus 10 is assembled and installed, spacer 74 contacts pipe 14 (shown in FIGS. 1-3). Further, in this embodiment, spacer 74 is located between pipe 14 (shown in FIGS. 1-3) and second part 72 (shown in FIG. 3). Further still, in the embodiment shown, second part 72 contacts spacer 74. In some embodiments, the spacer contacts the first part of the holder (e.g., in addition or instead). Still further, in a number of embodiments, spacer 74 is manufactured in different dimensions (e.g., thickness, radius of curvature, or both), for example, to accommodate different sizes of pipe 14, for example, while utilizing common sizes of first part 71, second part 72, or both. FIG. 6 may help to illustrate this aspect of some embodiments. Even further, in the embodiment shown, first holder 21 surrounds pipe 14. In other words, first holder 21 extends 360 degrees around pipe 14 when first holder 21 is installed on pipe 14 holding sensor 11 in contact with pipe 14. Moreover, in the embodiment illustrated, first part 71 connects to (e.g., attaches to) second part 72 on substantially opposite sides of pipe 14. In this context, “substantially opposite sides” means at least some contact between the two parts (e.g., parts 71 & 72) occurs 180 degrees apart, when measured from the pipe centerline, within plus or minus 30 degrees.

As shown in FIGS. 1-3, in some embodiments, pipe 14 is substantially vertical. In this context, “substantially vertical” means vertical to within 30 degrees. In other embodiments, the pipe may have a slope. In various embodiments, the pipe extends through the liquid levels being detected (e.g., 101, 102, & 103 shown in FIGS. 1 & 2). Further, in various embodiments, pipe 14 is non-metallic (e.g., plastic). Even further, in various embodiments, first part 71, second part 72, spacer 74, or a combination thereof, are plastic. Still further, in the embodiment shown, first sensor 11 is electronically read, for instance, via cable 41 identified in FIGS. 2-7. In various embodiments, other sensors, for instance, second sensor 12, third sensor 13, or both, are similarly electronically read. Further still, in the embodiment illustrated (e.g., in FIG. 1), apparatus 10 includes gateway box 16, which is electrically connected to first sensor 11, for instance, via cable 41. Furthermore, in the embodiment shown, gateway box 16, is electrically connected to second sensor 12 and third sensor 13. Moreover, in a number of embodiments, First sensor 11 is an ultrasonic, capacitive, or radar sensor, as examples. Second sensor 12 and third sensor 13 may be ultrasonic, capacitive, or radar sensors, may be interchangeable with sensor 11, or both, in some embodiments. Even further, in various embodiments, liquid 15 is oil (e.g., lubricating oil or hydraulic oil). Even further still, in the embodiment shown, pipe 14 is connected to (i.e., in fluid communication with) tank 17. In other words, liquid 15 is free to flow between pipe 14 and tank 17, for example, in the embodiment shown, at both the top and bottom of pipe 14.

Apparatus 10 is also an example of an apparatus for detecting a level (e.g., at least level 101 and 102, but in some embodiments also level 103) of a liquid (e.g., 15), wherein the apparatus includes (i.e., at least) two sensors (e.g., 11 & 12) and two holders (e.g., 21 & 22, for instance, shown in FIG. 2). In the embodiment shown (e.g., in FIG. 2), for example, apparatus 10 includes: first sensor 11 that detects first level 101 of liquid 15, first holder 21 that supports first sensor 11, second sensor 12 that detects second level 102 of liquid 15, and second holder 22 that supports second sensor 12. Further, in the embodiment shown (e.g., in FIG. 2), first holder 21 contacts pipe 14, and first sensor 11 detects first level 101 of liquid 15 in pipe 14. Further still, in the embodiment illustrated (e.g., in FIG. 2), second level 102 of liquid 15 is different than first level 101 of liquid 15. Even further, in the embodiment shown (e.g., in FIG. 2), second sensor 12 contacts pipe 14, and second sensor 12 detects second level 102 of liquid 15 in pipe 14.

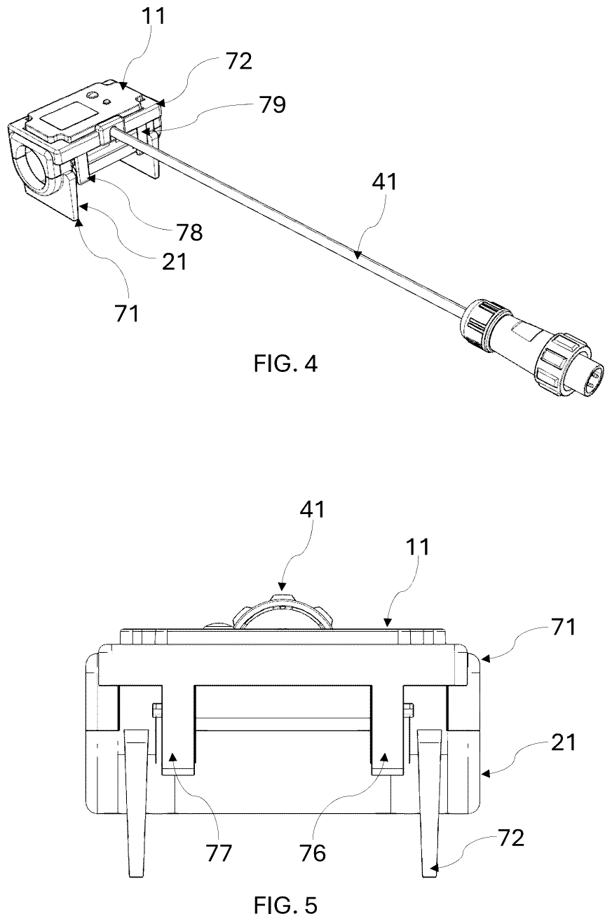

Further, in the embodiment illustrated (e.g., in FIG. 2), apparatus 10 includes third sensor 13 that detects third level 103 of liquid 15, and third holder 23 that supports third sensor 13. Still further, in the embodiment shown (e.g., in FIG. 2), third level 103 of liquid 15 is different than first level 101 of liquid 15. Further still, third level 103 of liquid 15 is different than second level 102 of liquid 15. Even further, in the embodiment illustrated, third holder 23 is interchangeable with first holder 21, third sensor 13 contacts pipe 14, and third sensor 13 detects third level 103 of liquid 15 in pipe 14. Further still, in the embodiment shown, first holder 21 further includes spacer 74 (e.g., shown in FIG. 4), and spacer 74 contacts pipe 14. Holders 22 and 23 may be similar in this regard. Even further, in a number of embodiments, spacer 74 may be manufactured in different dimensions (e.g., to accommodate different sizes of pipe 14). Even further still, in various embodiments, second sensor 12 is interchangeable with first sensor 11. Moreover, in a number of embodiments, first holder 21 surrounds pipe 14 (e.g., as shown in FIG. 3), pipe 14 is substantially vertical (e.g., as shown in FIGS. 1-3), pipe 14 is non-metallic, the holder (e.g., 11, 12, 13, or a combination thereof) is plastic, first sensor 11 is electronically read, first sensor 11 is an ultrasonic, capacitive, or radar sensor, liquid 15 is oil, pipe 14 is connected to tank 17, first sensor 11 detects first level 101 of the oil in tank 17, or a combination thereof.

In certain embodiments, an apparatus or system (e.g., 10) for detecting a level of a liquid (e.g., 15) uses one or more, (e.g., ultrasonic, capacitive, or radar) sensors (e.g., 11, 12, 13, or a combination thereof) to detect liquid level (e.g., oil level), for example, from outside of a tank (e.g., 17) that contains the liquid, for instance, by detecting the liquid level (e.g., 101, 102, 103, or a combination thereof) in a (e.g., non-metallic, for instance, plastic) pipe (e.g., 14) or tube (e.g., leveling tube), for example, that is connected to the tank (e.g., 17). Further, in a number of embodiments, the liquid (e.g., 15) has no direct contact with the sensor (e.g., 11, 12, 13, or a combination thereof). In particular embodiments, for example, avoiding liquid contact with the sensor increases the life of the sensor (e.g., 11, 12, 13, or a combination thereof), improves durability of the apparatus (e.g., 10), or both. In various embodiments, the sensor (e.g., 11, 12, 13, or a combination thereof) detects the liquid by sensing signals that penetrate the wall of the pipe (e.g., 14). Still further, in some embodiments, the sensor (e.g., 11, 12, 13, or a combination thereof) can detect or measure a variety of different liquids (e.g., 15), for instance, differing in density, composition, grade, or a combination thereof, for example, various oils of differing grade, milk, or water. Even further, in some embodiments, the (e.g., liquid level) sensor (e.g., 11, 12, 13, or a combination thereof) is installed on the (e.g., plastic) pipe (e.g., 14) of the (e.g., liquid) tank (e.g., 17). Even further still, in certain embodiments, the sensor, or multiple sensors (e.g., 11, 12, 13, or a combination thereof), detect the liquid level at multiple levels (e.g., 101, 102, 103, or a combination thereof), for instance, as required by the customer, for example, 50%, 25%, and low level (e.g., of tank 17). various embodiments include sensors position to detect a combination or subset of: Full, 95%, 90%, 80%, 75%, 70%, 2/3, 60%, 50%, 40%, 1/3, 30%, 25%, 20%, 10%, & 5%, (i.e., of full) as examples.

In certain embodiments, (e.g., built into the sensor) is a (e.g., battery powered) wireless gateway (e.g., 16). Further, in some embodiments, the sensor (e.g., 11, 12, 13, or a combination thereof) connects to the gateway, for example, through an aviation connector cable (e.g., 41 shown in FIGS. 2-7). Further still, some embodiments include cloud service, for example, that can provide real-time fluid level readings, threshold alerts, notifications, GPS location data, or a combination thereof, for instance, of each sensor gateway (e.g., 16). Even further, certain embodiments allow for logistics management, for instance, of when and where the container (e.g., tank 17) that stores the liquid (e.g., 15) being monitored needs to be replenished, for example, by the nearest delivery vehicle. Even further still, particular embodiments include various hardware (e.g., electronics), firmware, software, or a combination thereof.

Various embodiments include at least one (e.g., new) holder (e.g., 21, 22, 23, or a combination thereof), for instance, as illustrated in FIGS. 2-7. Further, in a number of embodiments, the sensor (e.g., one of 11, 12, or 13) is (e.g., securely) placed within the holder (e.g., one of 21, 22, or 23), for instance, for attachment, for example, to the pipe (e.g., 14). Still further, in some embodiments, the holder accommodates various pipe diameters (e.g., from 15 mm to 20 mm). Even further, in certain embodiments, this ensures, for example, a secure fit for the sensor (e.g., 11, 12, or 13). Further still, in various embodiments, the holder (e.g., 21, 22, or 23) positions (e.g., securely) the (e.g., ultrasonic, capacitive, or radar) sensor (e.g., 11, 12, or 13) on the pipe (e.g., 14), for example, for use with oil tanks (e.g., tank 17). Even further still, in some embodiments, the holder (e.g., 21, 22, or 23) is made of plastic material, is designed with (e.g., four) snap fasteners (e.g., 76, 77, 78, & 79 shown in FIG. 7, some also shown at least in FIGS. 3-5), for instance, to secure the sensor (e.g., one of 11, 12, or 13) to the (e.g., oil, for instance, 15) pipe (e.g., 14), or both. Moreover, in particular embodiments, several different holders (e.g., with inner sleeves or spacers, for instance, spacer 74) accommodate various pipe diameters (e.g., of pipe 14), for instance, ranging from 12 mm to 20 mm diameter. In certain embodiments, the appropriate inner sleeve or spacer (e.g., 74) is used to fix the holder (e.g., 21, 22, or 23) on the (e.g., oil 15) pipe (e.g., 14).

Other embodiments include an apparatus or method of obtaining or providing an apparatus or information, for instance, that include a novel combination of the features described herein. Even further embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations are potential embodiments. Some embodiments may include a subset of elements described herein and various embodiments include additional elements as well.

Further, various embodiments of the subject matter described herein include various combinations of the acts, structure, components, and features described herein, shown in the drawings, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. An apparatus for detecting a level of a liquid, the apparatus comprising:
a first sensor that detects a first level of the liquid; and
a first holder that supports the first sensor; wherein: the first holder comprises a first part and a second part; the first part connects to the second part around a pipe; the first sensor contacts the first part; the first sensor contacts the pipe; and
the first sensor detects the first level of the liquid in the pipe.

2. The apparatus of claim 1 further comprising:
a second sensor that detects a second level of the liquid wherein the second level of the liquid is different than the first level of the liquid; and
a second holder that supports the second sensor; wherein: the second holder is interchangeable with the first holder; the second sensor contacts the pipe; and the second sensor detects the second level of the liquid in the pipe.

3. The apparatus of claim 2 wherein the second sensor is interchangeable with the first sensor.

4. The apparatus of claim 2 further comprising:
a third sensor that detects a third level of the liquid; wherein: the third level of the liquid is different than the first level of the liquid and the third level of the liquid is different than the second level of the liquid; and
a third holder that supports the third sensor; wherein: the third holder is interchangeable with the first holder, the third sensor contacts the pipe; and the third sensor detects the third level of the liquid in the pipe.

5. The apparatus of claim 1 wherein: the first holder further comprises a spacer; the spacer is located between the pipe and the second part; the spacer contacts the pipe; and the second part contacts the spacer.

6. The apparatus of claim 5 wherein the spacer is manufactured in different dimensions to accommodate different sizes of the pipe while utilizing common sizes of the first part and the second part.

7. The apparatus of claim 1 wherein the first holder surrounds the pipe.

8. The apparatus of claim 1 wherein the first part connects to the second part on substantially opposite sides of the pipe.

9. The apparatus of claim 1 wherein the pipe is substantially vertical.

10. The apparatus of claim 1 wherein the pipe is non-metallic.

11. The apparatus of claim 1 wherein the first part and the second part are plastic.

12. The apparatus of claim 1 wherein the first sensor is electronically read.

13. The apparatus of claim 1 further comprising a gateway box electrically connected to the first sensor.

14. The apparatus of claim 1 wherein the first sensor is an ultrasonic, capacitive, or radar sensor.

15. The apparatus of claim 1 wherein the liquid is oil.

16. The apparatus of claim 1 wherein the pipe is connected to a tank and the first sensor detects the first level of the liquid in the tank.

17. An apparatus for detecting a level of a liquid, the apparatus comprising:
a first sensor that detects a first level of the liquid;
a first holder that supports the first sensor, wherein: the first holder contacts a pipe; and the first sensor detects the first level of the liquid in the pipe;
a second sensor that detects a second level of the liquid, wherein the second level of the liquid is different than the first level of the liquid; and
a second holder that supports the second sensor, wherein: the second sensor contacts the pipe; and the second sensor detects the second level of the liquid in the pipe.

18. The apparatus of claim 17 further comprising:
a third sensor that detects a third level of the liquid, wherein the third level of the liquid is different than the first level of the liquid and the third level of the liquid is different than the second level of the liquid; and
a third holder that supports the third sensor; wherein the third holder is interchangeable with the first holder, the third sensor contacts the pipe; and the third sensor detects the third level of the liquid in the pipe.

19. The apparatus of claim 17 wherein: the first holder further comprises a spacer; the spacer contacts the pipe; and the spacer is manufactured in different dimensions to accommodate different sizes of the pipe.

20. The apparatus of claim 17 wherein: the second sensor is interchangeable with the first sensor; the first holder surrounds the pipe; the pipe is substantially vertical; the pipe is non-metallic; the holder is plastic; the first sensor is electronically read; the first sensor is an ultrasonic, capacitive, or radar sensor; the liquid is oil; the pipe is connected to a tank; and the first sensor detects the first level of the oil in the tank.
